(19) United States
(12) Patent Application Publication
(10) Pub. No.: US 2004/0125105 A1
(43) Pub. Date: Jul. 1, 2004

(54) Method of reconstructing a regular 3D model by feature-line segmentation

(76) Inventors: Chia-Chen Chen, Hsinchu (TW); Wen-Shiou Lou, Hsinchu (TW)

Correspondence Address: BIRCH STEWART KOLASCH & BIRCH, PO BOX 747, FALLS CHURCH, VA, 22040-0747, US

(21) Appl. No.: 10/623,646

(22) Filed: Jul. 22, 2003

(30) Foreign Application Priority Data
Sep. 27, 2002 (TW) 091122290

(51) Int. Cl. G06T 17/00

(52) U.S. Cl. 345/420

(57) ABSTRACT

A method of reconstructing a regular 3D model by feature-line segmentation. The inventive method first inputs original 3D model data, builds 3D feature-lines, and converts the 3D feature-lines into 3D threads. The 3D threads have connection joints, connection lines, and loops. Next, the method determines sample numbers of the connection lines, adds or deletes the loops, and outputs the 3D threads. Finally, a regular triangular grid sample model is then produced according to the 3D threads and projected into the original 3D model to produce a reconstructed 3D model. The reconstructed 3D model can be adjusted if resolution requirements are still unsatisfied.

### BACKGROUND OF THE INVENTION

1. Field of the Invention

The present invention relates to a 3D model reconstruction technology, and in particular to a computer-implemented method of reconstructing regular 3D models by feature-line segmentation.

2. Description of the Related Art

3D model data obtained from a 3d scanner or 3D drawing tool is immediately useless because of the enormous amount, irregularity, and incompleteness of data. Therefore, the obtained data must be processed further for utilization, such as by segmentation, simplification, integration, or reconstruction. Conventionally, these further processes are executed manually. However, the manual processing method is time-consuming and cannot reconstruct a satisfied 3D model if the obtained data is irregular or incomplete.

Another method applies an automatic simplification program to process the obtained 3D model data, such as that U.S. Pat. No. 6,285,372 discloses. The exterior characteristics and grid regularity of the reconstructed 3D model can maintain quality by the automatic simplification program. However, the structure and distribution of grids are usually not satisfied, reducing authenticity. Moreover, to modify the reconstructed 3D model partially, the automatic simplification program must be changed. In other words, the automatic simplification program cannot adjust the reconstructed 3D model flexibly according to requirements, presenting inconvenience for data processing. Thus, the conventional method and the automatic simplification program cannot satisfy actual requirements.

### SUMMARY OF THE INVENTION

Accordingly, an object of the invention is to provide a procedural methodology to transfer a original complex 3D model into a regular 3D model, solving conventional 3D model reconstruction problems.

Another object of the invention is to provide an interactive method to allow interruption of data processing for partial adjustment of reconstructed 3D models.

To achieve the foregoing and other objects, the invention overcomes conventional 3D model reconstruction problems. The inventive method inputs original 3D model data and builds 3D feature-lines according to the original 3D model data before converting them into 3D threads. The 3D threads comprise connection joints, connection lines, and loops. Next, the method determines sample numbers of the connection lines, adds or deletes the loops, and outputs the 3D threads. The method then produces a regular triangular grid sample model according to the 3D threads. Finally, the method projects the regular triangular grid sample model into the original 3D model to produce a reconstructed 3D model.

### BRIEF DESCRIPTION OF THE DRAWINGS

The present invention can be more fully understood by reading the subsequent detailed description and examples with references made to the accompanying drawings, wherein:

FIG. 1 is a flowchart of the computer-implemented method of reconstructing regular 3D model by feature-line segmentation.

FIG. 2 is the original 3D model according to the invention.

FIG. 3 shows the 3D feature-lines according to the invention.

FIG. 4 shows the 3D threads and the sample points according to the invention.

FIG. 5A, FIG. 5B are regular triangular grid sample models according to the invention.

FIG. 6A, FIG. 6B are reconstructed 3D models according to the invention.

FIG. 7A, FIG. 7B are reconstructed 3D models with partially enhanced resolution according to the invention.

### DETAILED DESCRIPTION OF THE INVENTION

As summarized above, the present invention is directed to novel methods for overcoming conventional 3D model reconstruction problems. The inventive method first inputs original 3D model data, and builds 3D feature-lines according to the original 3D model data. The 3D feature-lines are based on the exterior appearance and structure of the original 3D model.

The method then converts the 3D feature-lines into 3D threads. The 3D threads comprise connection joints, connection lines, and loops. The transfer is accomplished by following detailed executive steps. First, all intersection points of the 3D feature-lines are obtained as the connection joints. Next, the connection lines connecting to each connection joint are recorded. Finally, all the connection lines constructing closed zones are searched as the loops.

Next, the method determines sample numbers of the connection lines, adds or deletes the loops, and outputs the 3D threads. The method then produces a regular triangular grid sample model according to the 3D threads. The production is accomplished by certain detailed steps. That is, regular triangular grids are first constructed in the loops according to the sample numbers of the connection lines. All the closed regular triangular grids of the loops are then combined as the regular triangular grid sample model.

Finally, the method projects the regular triangular grid sample model into the original 3D model to produce a reconstructed 3D model.

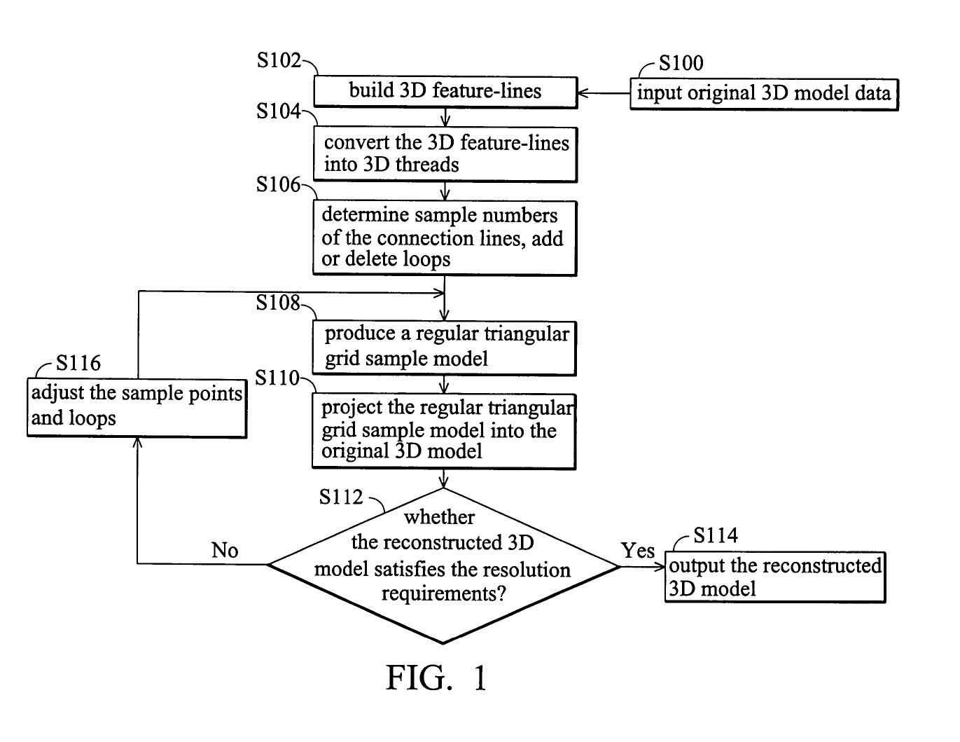

FIG. 1 is a flowchart of the computer-implemented method of reconstructing a regular 3D model by feature-line segmentation. The inventive method first inputs original 3D model data (step S100). Next, the method builds 3D feature-lines according to the original 3D model data (step S102) and converts the 3D feature-lines into 3D threads (step S104). The 3D threads are comprised of connection joints, connection lines, and loops.

Next, the method determines sample numbers of the connection lines, adds or deletes the loops, and outputs the 3D threads (step S106). The method then produces a regular triangular grid sample model according to the 3D threads (step S108).

Finally, the method projects the regular triangular grid sample model into the original 3D model to produce a reconstructed 3D model (step S110). The method may examine whether the reconstructed 3D model satisfies the resolution requirements (step S112). If the reconstructed 3D model does not satisfy the resolution requirement, the method adjusts the sample points and loops (step S116), and repeats steps S108, S110 until the reconstructed 3d model satisfies the resolution requirement. In the step S112, if the reconstructed 3D model satisfies the resolution requirements already, the method outputs the reconstructed 3d model (step S114).

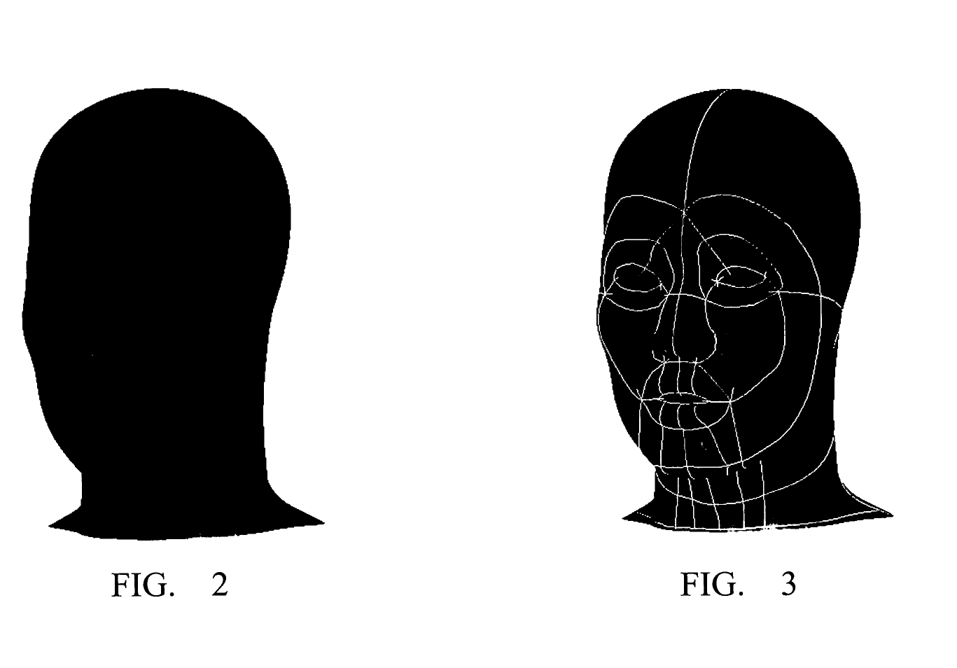

FIG. 2 is the original 3D model according to the invention. In one embodiment, the original 3D model has 363752 polygons, as shown in FIG. 2. The method builds 3D feature-lines according to the original 3D model data. FIG. 3 shows the 3D feature-lines according to the invention. The 3D feature-lines can be produced manually or automatically by programs. Obviously, the 3D feature-lines share the characteristics of the exterior appearance and structure of the original 3D model as shown in FIG. 2. The 3D feature-lines are the base for further data processing.

Next, the method converts the 3D feature-lines into 3D threads. The 3D threads are comprised of connection joints, connection lines, and loops. The transfer includes several detailed steps. First, the method obtains all intersection points of the 3D feature-lines as the connection joints. The method then records the connection lines that connect to each connection joint. The method finally searches all the connection lines that construct closed zones as the loops. More specifically, the connection joints are the intersecting points of the 3D feature-lines. The connection lines are parts of the 3D feature-lines. The loops are comprised of the connection lines. The main function of the transfer is to alter the irregular 3D feature-lines into the structured regular 3D threads.

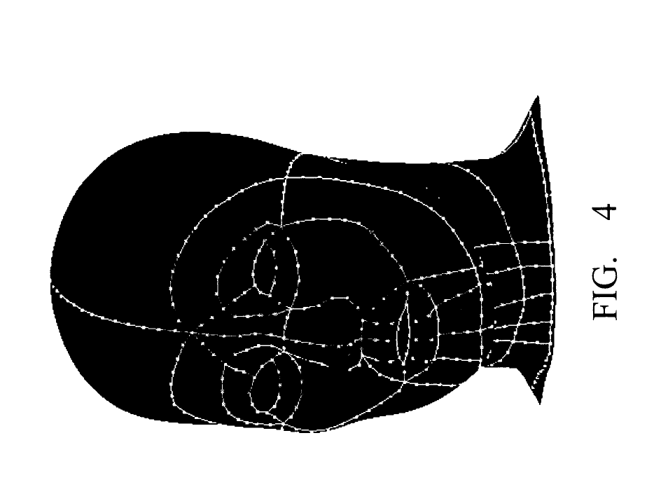

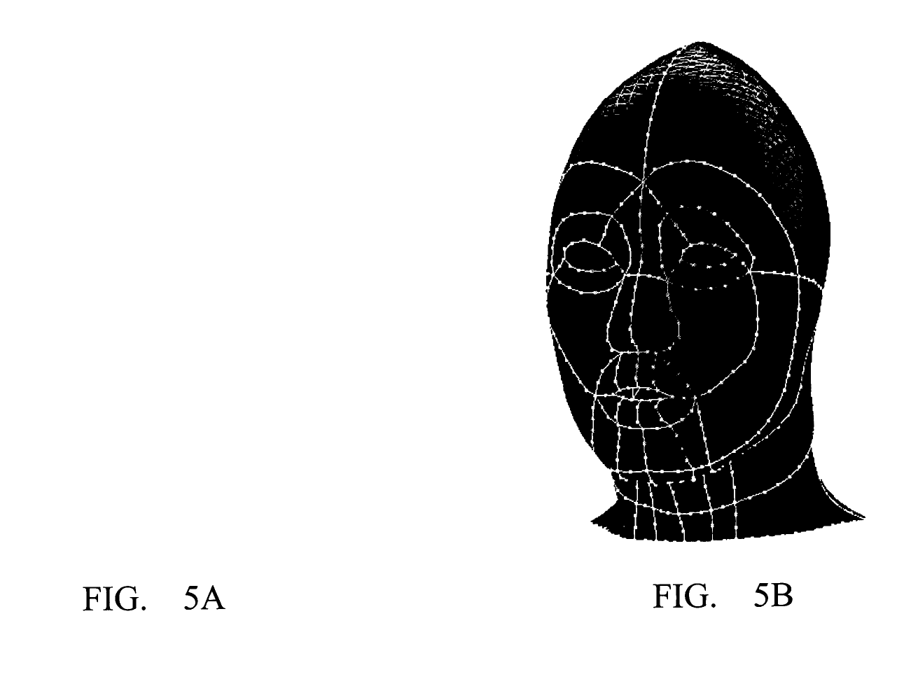

Carrying on, the method determines sample numbers of the connection lines, adds or deletes the loops, and outputs the 3D threads. The sample numbers affect the density of grids, i.e. the more sample points, the denser the grids. The loops affect the structure of the grids. FIG. 4 shows the 3D threads and the sample points according to the invention.

Next, the method produces a regular triangular grid sample model according to the 3D threads, as shown in FIGS. 5A, 5B. FIG. 5A, and FIG. 5B are regular triangular grid sample models according to the invention. The structure of the triangular grid sample model can be totally controlled through the mentioned 3D threads.

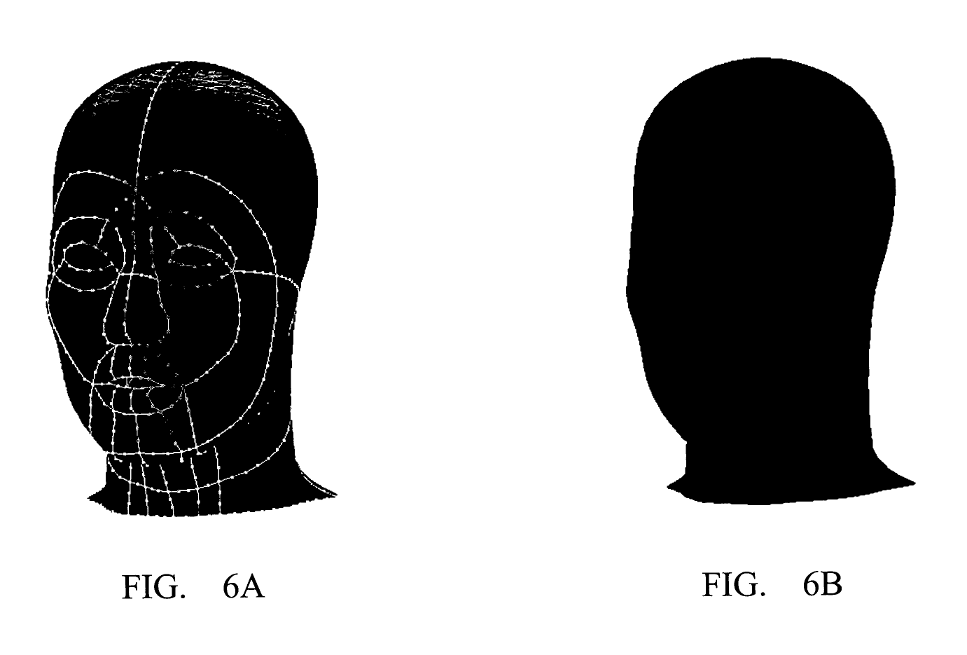

Finally, the method projects the regular triangular grid sample model into the original 3D model to produce a reconstructed 3D model. FIG. 6A, FIG. 6B are reconstructed 3D models according to the invention. As shown in FIGS. 6A, 6B, the regular reconstructed 3D model has regular triangular grid structure and maintains the exterior appearance of the original 3D model. The reconstructed 3D model has 3947 polygons. Compared to the original 3D model, the reconstructed 3D model has obviously reduced data, enhancing applicable probability. Thus, a regular reconstructed 3D model is produced.

The reconstructed 3D model can satisfy resolution requirements as assessed by the method. If not, satisfy the resolution requirements, the method adjusts the sample points and loops, such as redetermining sample numbers of the connection lines, readding or redeleting the loops, until the reconstructed 3D model satisfies the resolution requirements. If the reconstructed 3d model satisfies the resolution requirements, the method then outputs the reconstructed 3d model.

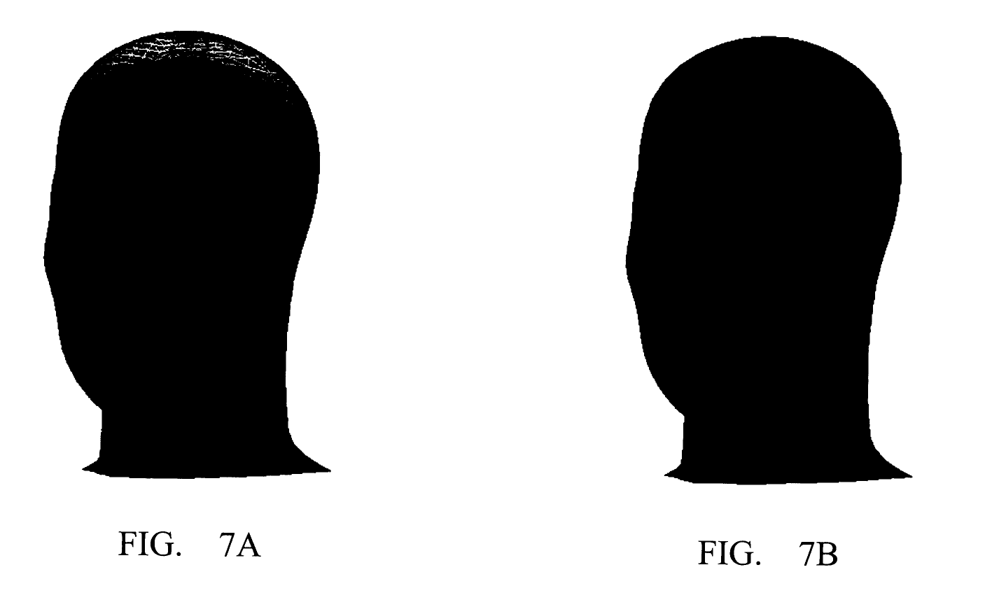

Users can enhance the partial resolution of the reconstructed model through an interface according to actual need. FIG. 7A, FIG. 7B are reconstructed 3D models with partially enhanced resolution according to the invention. As shown in FIGS. 7A, 7B, the partial resolution of the eyes, nose, and the month is enhanced.

Thus, a method of reconstructing regular 3D models by feature-line segmentation is provided by the invention. The disclosed method transforms the original complex 3D model into a reconstructed 3D model. The reconstructed 3D model shares the regular triangular grid structure and the exterior characteristics of the original 3D model, solving present 3D model reconstruction problems. Through an interface, users can interrupt the data processing and enhance the partial resolution according to needs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer-implemented method of reconstructing a regular 3D model by feature-line segmentation, comprising using a computer to perform the steps of:
(a) inputting original 3D model data;
(b) building 3D feature-lines according to the original 3D model data;
(c) converting the 3D feature-lines into 3D threads having respective pluralities of connection joints, connection lines, and loops;
(d) determining sample numbers of each connection line, adding or deleting the loops, and outputting the 3D threads;
(e) producing a regular triangular grid sample model according to the 3D threads;
(f) projecting the regular triangular grid sample model into the original 3D model to produce a reconstructed 3D model;
(g) redetermining sample numbers for each connection line, readding or redeleting the loops, and repeating steps (e) and (f) if the reconstructed 3D model does not satisfy resolution requirements, and outputting the reconstructed 3D model if the reconstructed 3D model satisfies the resolution requirements.

2. The computer-implemented method as claimed in claim 1, wherein the 3D feature-lines in step (b) are based on the exterior appearance and structure of the original 3D model.

3. The computer-implemented method as claimed in claim 1, wherein step (c) further comprises the steps of:
obtaining intersection points of the 3D feature-lines as the connection joints;
recording the connection lines connecting to each connection joint; and
searching the connection lines constructing closed zones as the loops.

4. The computer-implemented method as claimed in claim 1, wherein step (e) further comprises the steps of:
constructing regular triangular grids in each loop according to the sample numbers of each connection line in step (d); and
combining the closed regular triangular grids of the loops as the regular triangular grid sample model.

5. A computer-implemented method of reconstructing a regular 3D model by feature-line segmentation, comprising using a computer to perform the steps of:
inputting original 3D model data;
building 3D feature-lines according to the original 3D model data;
converting the 3D feature-lines into 3D threads having respective pluralities of connection joints, connection lines, and loops;
determining sample number of each connection line, adding or deleting the loops, and outputting the 3D threads;
producing a regular triangular grid sample model according to the 3D threads;
projecting the regular triangular grid sample model into the original 3D model to produce a reconstructed 3D model;
outputting the reconstructed 3D model.

6. The computer-implemented method as claimed in claim 5, wherein the 3D feature-lines in the build step are based on the exterior appearance and structure of the original 3D model.

7. The computer-implemented method as claimed in claim 5, wherein the conversion step further comprises the steps of:
obtaining intersection points of the 3D feature-lines as the connection joints;
recording the connection lines connecting to each connection joint; and
searching the connection lines constructing closed zones as the loops.

8. The computer-implemented method as claimed in claim 5, wherein the producing step further comprises the steps of:
constructing regular triangular grids in each loop according to the sample numbers of each connection line in the determination step; and
combining the closed regular triangular grids of the loops as the regular triangular grid sample model.
